(19) United States
(12) Patent Application Publication
(10) Pub. No.: US 2026/0079232 A1
(43) Pub. Date: Mar. 19, 2026

(54) RADAR INTERFERENCE MITIGATION

(71) Applicant: GM GLOBAL TECHNOLOGY OPERATIONS LLC, DETROIT, MI (US)

(72) Inventors: Oren Longman, Raanana (IL); Guy Mardiks, Raanana (IL)

(21) Appl. No.: 18/885,943

(22) Filed: Sep. 16, 2024

(51) Int. Cl. G01S 7/02; G01S 7/288; G01S 13/931

(52) U.S. Cl. CPC G01S 7/0235; G01S 7/0232; G01S 7/2883; G01S 13/931

(57) ABSTRACT

Examples described herein provide a method for radio detecting and ranging (radar) interference mitigation for a vehicle. The method includes receiving radar data, the radar data captured by a radar device of the vehicle and being indicative of an environment in which the vehicle operates, the radar data including interference. The method further includes performing temporal signal reconstruction on the radar data prior to performing a fast Fourier transform (FFT) on the radar data to generate first filtered data, wherein the FFT generates ranging data using the first filtered data. The method further includes performing spectral signal reconstruction on the ranging data subsequent to performing the FFT on the ranging data to generate second filtered data. The method further includes detecting an object in the environment based at least in part on the second filtered data.

The subject disclosure relates to vehicles, and in particular to radio detecting and ranging (radar) interference mitigation.

Modern vehicles (e.g., a car, a motorcycle, a boat, or any other type of automobile) may be equipped with sensors, such as a radar device(s), for performing perception tasks Radar involves emitting radio waves and detecting the echoes that bounce back when the emitted radio waves encounter objects. By measuring the time it takes for the echo to return and the frequency shift of the waves, radar systems can determine the distance, speed, and direction of travel of the objects.

Perception tasks can include one or more of object detection, classification, tracking, lane detection, road sign recognition, and obstacle avoidance. Perception tasks are particularly useful for an autonomous vehicle or semi-autonomous vehicle to provide the vehicle with real-time awareness of its environment to make safe and informed driving decisions. The data collected by a radar device, for example, can be used to perform perception tasks.

### SUMMARY

In one embodiment, a method for radio detecting and ranging (radar) interference mitigation for a vehicle is provided. The method includes receiving radar data, the radar data captured by a radar device of the vehicle and being indicative of an environment in which the vehicle operates, the radar data including interference. The method further includes performing temporal signal reconstruction on the radar data prior to performing a fast Fourier transform (FFT) on the radar data to generate first filtered data, wherein the FFT generates ranging data using the first filtered data. The method further includes performing spectral signal reconstruction on the ranging data subsequent to performing the FFT on the ranging data to generate second filtered data. The method further includes detecting an object in the environment based at least in part on the second filtered data.

In addition to one or more of the features described herein, or as an alternative, further embodiments of the method may include that the temporal signal reconstruction includes performing a detection stage and a reconstruction stage to detect interference values within the radar data and interpolate replacement values to replace the interference values.

In addition to one or more of the features described herein, or as an alternative, further embodiments of the method may include that the detection stage includes determining a median absolute value of the time samples for each chirp across the plurality of chirps of the radar data, determining a third quartile of the median values, determining an interquartile range (IQR) using subtraction of the third quartile and the first quartile, and identifying outliers based on a first threshold.

In addition to one or more of the features described herein, or as an alternative, further embodiments of the method may include that the detection phase includes a first detection phase, and wherein the temporal signal reconstruction further includes a second detection stage, wherein the second detection stage includes determining a third quartile of absolute samples values across the chirps of the plurality of chirps for each time index, determining the IQR using subtraction of the third quartile of the absolute samples values and a first quartile of the absolute samples values, and identifying outliers based on a second threshold.

In addition to one or more of the features described herein, or as an alternative, further embodiments of the method may include that the reconstruction stage includes detecting which points within the radar data are greater than the first threshold, and interpolating the replacement values to replace the points greater than the first threshold based on neighboring points.

In addition to one or more of the features described herein, or as an alternative, further embodiments of the method may include that the temporal signal reconstruction includes performing a first detection stage, a first restoration stage, a second detection stage, and a second reconstruction stage to detect interference values within the radar data and interpolate values to replace the interference values.

In addition to one or more of the features described herein, or as an alternative, further embodiments of the method may include that the spectral signal reconstruction includes performing a detection stage and a reconstruction stage to detect interference values within the ranging data and interpolate values to replace the interference values, wherein the detection stage includes determining a median absolute value of range samples for each of a plurality of chirps of the ranging data, determining a third quartile of the median values, determining an interquartile range (IQR) using a subtraction of a third quartile and a first quartile, and identifying outliers based on a first threshold.

In addition to one or more of the features described herein, or as an alternative, further embodiments of the method may include that the detection phase includes a first detection phase, and wherein the temporal signal reconstruction further includes a second detection stage, wherein the second detection stage includes determining a third quartile of absolute samples values across the chirps of the plurality of chirps for each range index, determining the IQR using subtraction of the third quartile of the absolute samples values and a first quartile of the absolute samples values, and identifying outliers based on a second threshold.

In addition to one or more of the features described herein, or as an alternative, further embodiments of the method may include that the reconstruction stage includes detecting which points within the ranging data are greater than the first threshold, and interpolating replacement values to replace the points greater than the first threshold based on neighboring points.

In addition to one or more of the features described herein, or as an alternative, further embodiments of the method may include that the spectral signal reconstruction includes performing a first detection stage, a first restoration stage, a second detection stage, and a second reconstruction stage to detect interference values within the ranging data and interpolate values to replace the interference values.

In another embodiment, a vehicle is provided. The vehicle includes a radar device, the radar device emitting radio waves and detecting echoes that bounce back when the radio waves encounter an object. The vehicle further includes a processing system having a memory including computer readable instructions and a processing device for executing the computer readable instructions. The computer readable instructions control the processing device to perform operations for radio detecting and ranging (radar) interference mitigation. The operations include receiving radar data from the radar device, the radar data being indicative of an environment in which the vehicle operates, the radar data including interference. The operations include performing temporal signal reconstruction on the radar data prior to performing a fast Fourier transform (FFT) on the radar data to generate first filtered data, wherein the FFT generates ranging data using the first filtered data. The operations include performing spectral signal reconstruction on the ranging data subsequent to performing the FFT on the ranging data to generate second filtered data. The operations include detecting an object in the environment based at least in part on the second filtered data.

In addition to one or more of the features described herein, or as an alternative, further embodiments of the vehicle may include that the temporal signal reconstruction includes performing a detection stage and a reconstruction stage to detect interference values within the radar data and interpolate replacement values to replace the interference values.

In addition to one or more of the features described herein, or as an alternative, further embodiments of the vehicle may include that the detection stage includes determining a median absolute values of the time samples across each of a plurality of chirps of the radar data, determining a third quartile of the median values, determining an interquartile range (IQR) using subtraction of the third quartile and a first quartile, and identifying outliers based on a threshold.

In addition to one or more of the features described herein, or as an alternative, further embodiments of the vehicle may include that the reconstruction stage includes detecting which points within the radar data are greater than the threshold, and interpolating the replacement values to replace the points greater than the threshold based on neighboring points.

In addition to one or more of the features described herein, or as an alternative, further embodiments of the vehicle may include that the temporal signal reconstruction includes performing a first detection stage, a first restoration stage, a second detection stage, and a second reconstruction stage to detect interference values within the radar data and interpolate values to replace the interference values.

In addition to one or more of the features described herein, or as an alternative, further embodiments of the vehicle may include that the spectral signal reconstruction includes performing a detection stage and a reconstruction stage to detect interference values within the ranging data and interpolate values to replace the interference values.

In addition to one or more of the features described herein, or as an alternative, further embodiments of the vehicle may include that the detection stage includes determining a median absolute values of range samples across each of a plurality of chirps of the ranging data, determining a third quartile of the median values, determining an interquartile range (IQR) using subtraction of the third quartile and a first quartile, and identifying outliers based on a threshold.

In addition to one or more of the features described herein, or as an alternative, further embodiments of the vehicle may include that the reconstruction stage includes detecting which points within the ranging data are greater than the threshold, and interpolating replacement values to replace the points greater than the threshold based on neighboring points.

In addition to one or more of the features described herein, or as an alternative, further embodiments of the vehicle may include that the spectral signal reconstruction includes performing a first detection stage, a first restoration stage, a second detection stage, and a second reconstruction stage to detect interference values within the ranging data and interpolate values to replace the interference values.

In another embodiment a method is provided. The method includes receiving radar data, the radar data captured by a radar device of a vehicle and being indicative of an environment in which the vehicle operates, the radar data including interference. The method further includes performing initial filtering on the radar data using a low pass filter to generate filtered radar data. The method further includes converting the filtered radar data from analog signals into digital form to generate digital filtered radar data. The method further includes performing temporal signal reconstruction on the digital filtered radar to generate first filtered data. The method further includes performing a range fast Fourier transform (FFT) to convert the first filtered data from a time domain to a frequency domain to generate ranging data. The method further includes performing spatial signal reconstruction on the ranging data to generate second filtered data. The method further includes performing a doppler FFT to analyze a frequency shift of the second filtered data. The method further includes performing digital beam forming after the doppler FFT. The method further includes detecting an object in the environment based at least in part on the second filtered data subsequent to performing the doppler FFT and the digital beam forming.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is an illustration of a vehicle having a processing system for radar interference mitigation according to one or more embodiments;

FIG. 2A is a block diagram of the processing system of FIG. 1 for radar interference mitigation according to one or more embodiments;

FIG. 2B is an example of radar data having interference according to one or more embodiments;

FIG. 3 is a block diagram of an environment for radar interference mitigation according to one or more embodiments;

FIG. 4 is a block diagram of a system for radar interference mitigation for a vehicle according to one or more embodiments; and

FIG. 5 is a flow diagram of a method for radar interference mitigation for a vehicle according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to radar interference mitigation.

Vehicles may use advanced driver assistance systems (ADASs) to improve vehicle performance and enhance driving comfort by providing automating, adapting, or enhancing vehicle systems to provide better awareness, decision-making, and control. ADASs often use data from sensors (e.g., radar device(s), LiDAR device(s), proximity sensors, etc.), images from cameras, and/or the like, including combinations and/or multiples thereof, to make decisions and control one or more aspects of the vehicle.

One example of an ADAS is adaptive cruise control (ACC) system, which automatically adjusts the velocity of a host vehicle to maintain a safe following distance from another vehicle ahead of the vehicle. Another example of an ADAS is an automated lane change (ALC) system to cause the host vehicle to perform a lane change. Another example of an ADAS is a front collision alert (FCA) system to generate an alert to an operator of the host vehicle warning of a potential front collision. Another example of an ADAS is a collision imminent braking (CIB) system to apply brakes of the host vehicle to reduce a velocity of the host vehicle. Another example of an ADAS is an automated evasive steering (AES) system to adjust the trajectory of the host vehicle.

Although various ADASs are useful for their intended purposes, such systems can be negatively influenced by radar interference. For example, a vehicle having a radar device is susceptible to interference from another radar device (e.g., a radar device in another vehicle). Radar interference is expressed in a raised noise floor in radar processing, leading to an increase in false alarms (e.g., detecting an object that is not actually present) or prevention of target detection (e.g., an object that is present is not actually detected). For automotive applications, false alarms may cause false actions from ADASs, such as false emergency breaking or false velocity adjustment. Prevention of target detection may cause prevention of desired ADAS actions, such as prevention of emergency breaking or prevention of velocity adjustment.

One or more embodiments described herein address these and other shortcomings by providing for radar interference mitigation, particularly in automotive implementations. More particularly, one or more embodiments described herein performs temporal signal reconstruction and/or spectral signal reconstruction to reduce or eliminate interference in radar data. According to one or more embodiments, temporal signal reconstruction is performed after analog-to-digital conversion sampling in the temporal domain and before a range fast Fourier transform (FFT) is performed. Then, once the range FFT is performed, spectral signal reconstruction is performed in the spectral (e.g., frequency) domain, which identifies and removes abnormal energy spikes in the radar data. By identifying and replacing interfered samples (e.g., time samples for the temporal signal reconstruction and range samples for the spectral signal reconstruction), the effect of interference is reduced.

It should be appreciated that the functioning of a vehicle implementing one or more of the embodiments described herein is improved. For example, a vehicle can reduce or eliminate interference in radar signals, which results in more accurate data that in turn enables the vehicle to make more accurate decisions in the context of ADASs. This results in improved operation of the vehicle, for example, by reducing or eliminating false alarms that cause false actions from ADASs, such as false emergency breaking or false velocity adjustment, and/or by improving target detection to improve emergency breaking or velocity adjustment.

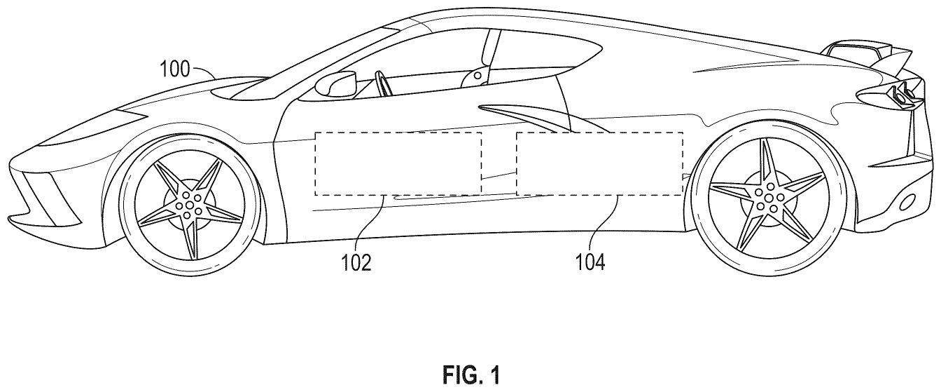

FIG. 1 is an illustration of a vehicle 100 having a processing system 102 for radar interference mitigation according to one or more embodiments. The vehicle 100, which is also referred to herein as a “host vehicle,” can be a car, a truck, a van, a bus, a motorcycle, a boat, or any other type of automobile. According to an embodiment, the vehicle 100 includes an internal combustion engine fueled by gasoline, diesel, or the like. According to another embodiment, the vehicle 100 is a hybrid electric vehicle partially or wholly powered by electrical power. According to another embodiment, the vehicle 100 is an electric vehicle powered by electrical power. According to one or more embodiments, the vehicle 100 is an autonomous or semi-autonomous vehicle. An autonomous vehicle is a vehicle that has self-driving capabilities.

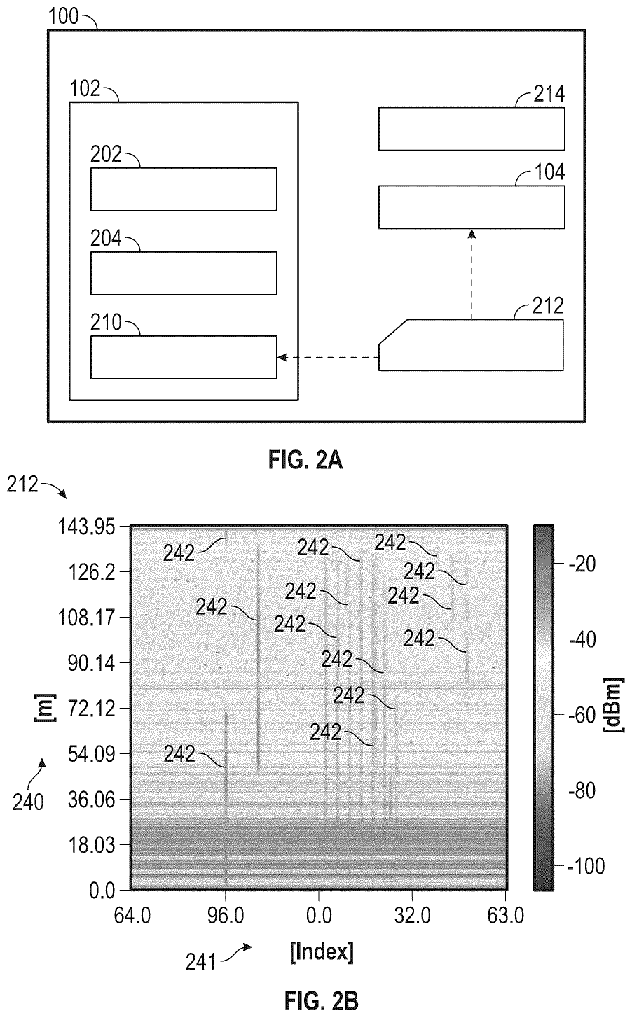

According to one or more embodiments, the vehicle 100 includes the processing system 102, which provides for radar interference mitigation. Further features of the processing system 102 are now described with reference to FIGS. 2-5.

Particularly, FIG. 2A is a block diagram of the processing system 102 of FIG. 1 for radar interference mitigation according to one or more embodiments. The processing system 102 includes a processing device 202, a memory 204, and a detection engine 210 for radar interference mitigation. It should be appreciated that the processing system 102 can be any device suitable for performing radar processing. For example, the processing system 102 can be a device implemented in or otherwise associated with the vehicle 100. As another example, the processing system 102 can be a smartphone, tablet computer, laptop computer, desktop computer, wearable computing device, and/or the like, including combinations and/or multiples thereof.

The processing device 202 is any suitable processing circuitry for processing data and/or instructions. In aspects of the present disclosure, the processing device 202 is a reduced instruction set computer (RISC) microprocessor or the like.

The memory 204 is any suitable device for storing data and/or instructions. The memory 204 can include one or more temporary and/or persistent memory devices, such as a random-access memory (RAM), read-only memory (ROM), and/or the like, including combinations and/or multiples thereof.

The detection engine 210 uses radar data 212 to detect objects as is further described herein. The radar data 212 can include data from one or more radar device, such as the radar device 104 associated with the vehicle 100. The radar data 212 can include interference, such an interference caused by other radar devices (e.g., a radar device disposed in another vehicle). The detection engine 210 can analyze and process the radar data 212 to remove or reduce the interference. FIG. 2B is an example of the radar data 212, in this example after range FFT, having interference according to one or more embodiments. In this example, the radar data 212 are shown in terms of range value 240 (e.g., in meters) (y-axis) for each chirp 241 (indexed) (x-axis). The vertical lines 242 represent interference. As described herein and as illustrated in FIG. 2B, each chirp index (x-axis) includes range data arranged in a column, and for each range value 240 (y-axis), the chirp index is arranged in a row.

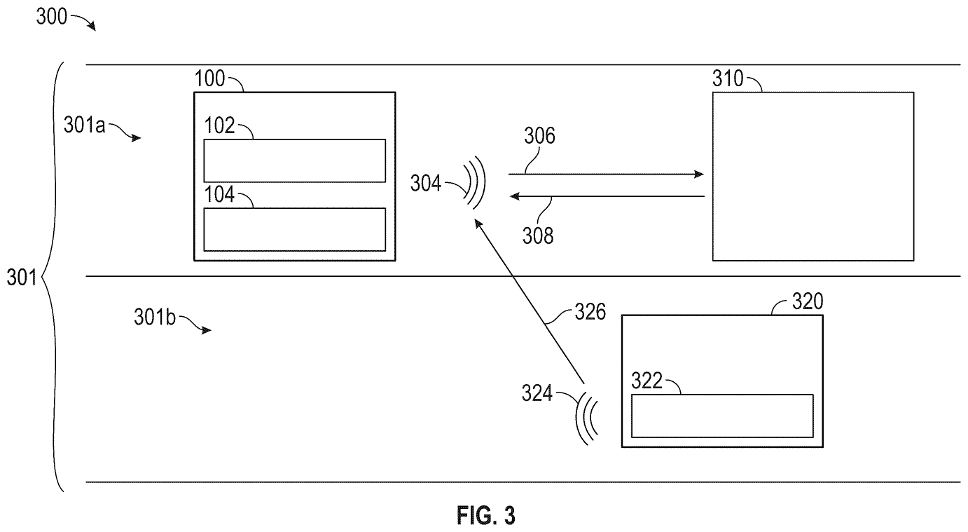

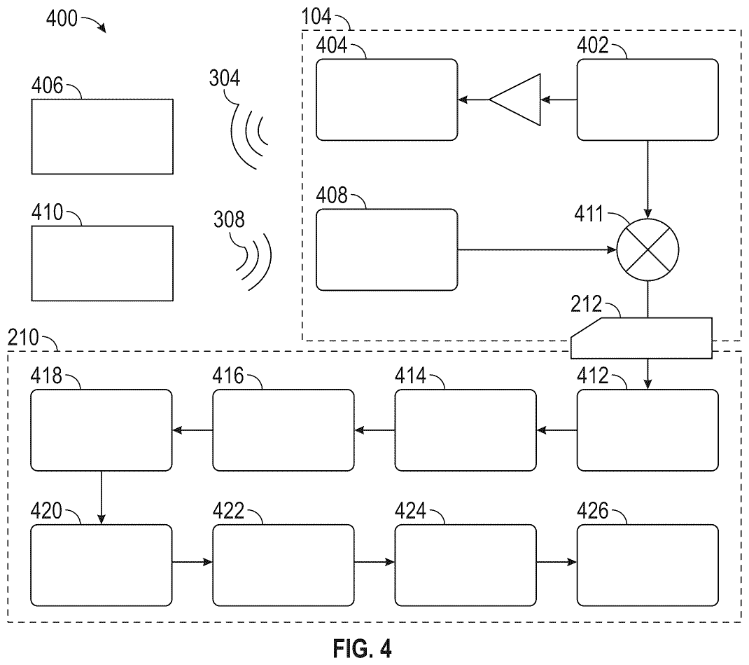

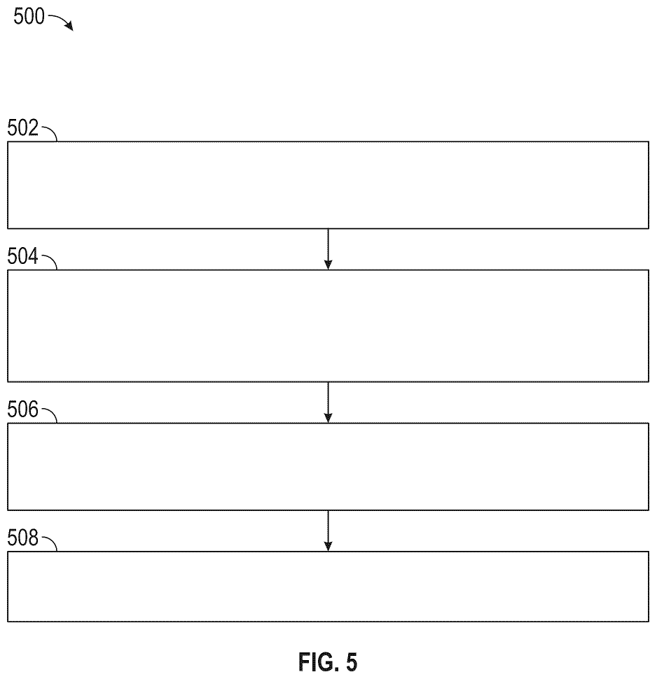

With continued reference to FIG. 2A, according to one or more embodiments, the detection engine 210 performs temporal signal reconstruction and/or spectral signal reconstruction to reduce or eliminate the interference in the radar data 212. According to one or more embodiments, temporal signal reconstruction is performed after analog-to-digital conversion sampling in the temporal domain and before a range FFT is performed (as further described herein with reference to FIGS. 4 and 5). Then, once the range FFT is performed, spectral signal reconstruction is performed in the spectral (e.g., frequency) domain (as further described herein with reference to FIGS. 4 and 5), which identifies and removes abnormal energy spikes in the radar data. By identifying and replacing interfered samples, the effect of interference within the radar data 212 is reduced, enabling the detection engine 210 to perform more accurate object detection, which may in turn be used to perform perception tasks, operate one or more ADAS, and/or to directly operate the vehicle 100. Further aspects and features of the detection engine 210 are described herein with respect to FIGS. 3-5.

The various components, modules, engines, etc. described regarding FIG. 2A (e.g., the detection engine 210) can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the various components, modules, engines, etc. described herein can be a combination of hardware and programming. The programming can be processor executable instructions stored on a tangible memory, and the hardware can include the processing device 202 for executing those instructions. Thus, a system memory (e.g., memory 204) can store program instructions that, when executed by the processing device 202, implement the engines described herein. Other components, modules, engines, etc. can also be utilized to include other features and functionality described in other examples herein.

According to one or more embodiments, the vehicle 100 includes an ADAS 214, which provides one or more advanced driver assistance functions. For example, the ADAS 214 can provide one or more of ACC, ALC, FCA, CIB, AES, and/or the like, including combinations and/or multiples thereof.

Turning now to FIG. 3, a block diagram of an environment 300 for radar interference mitigation according to one or more embodiments is shown. The environment 300 represents a real-world environment in which the vehicle operates. In this example, the environment 300 includes a road 301 having a first lane 301a and a second lane 301b. The vehicle 100 and a target vehicle 310 occupy the first lane 301a, and an interfering vehicle 320 occupies the second lane 301b. The radar device 104 of the vehicle 100 emits radio waves 304 in the form of a chirp 306. The chirp 306 is one of multiple signals that the radar device 104 emits over time. According to one or more embodiments, the radar device 104 uses frequency modulation, which increases or decreases the frequency of the radio waves (e.g., the chirp 306) over time. This approach improves determining the distance to the target vehicle 310 by enhancing the resolution and reducing the effects of noise. The radar device 104 detects an echo 308 that bounces back when the emitted radio waves (e.g., the chirp 306) encounter the target vehicle 310. Together, the chirp 306 and the echo 308 are used by the detection engine 210, FIG. 2A, to determine the distance from the vehicle 100 to the target vehicle 310.

The interfering vehicle 320 includes a radar device 322 that also emits radio waves 324. These radio waves 324 interfere with the radar device 104 of the vehicle 100, in the form of interference 326, when the interfering vehicle 320 is within a certain range/proximity of the vehicle 100. The range/proximity for causing the interference 326 is determined, for example, based on the range of the radar device 104, the range of the radar device 322, environmental conditions (e.g., humidity, temperature, terrain/topology, and/or the like, including combinations and/or multiples thereof).

FIG. 4 is a block diagram of a system 400 for radar interference mitigation for a vehicle according to one or more embodiments. The system 400 includes at least the radar device 104 and the detection engine 210.

The radar device 104 uses a linear frequency modulator (LFM) 402 in one embodiment, other waveforms are used in other embodiments, to generate radio waves (e.g., the radio waves 304) from a transmitter (Tx) antenna 404. The radio waves that encounter objects 406 (e.g., the target vehicle 310) are returned to a receiver (Rx) antenna 408 of the radar device 104 as echoes (e.g., the echo 308). The receiver (Rx) antenna 408 also receives radio waves from interference radars 410 (e.g., the radar device 322 of the interfering vehicle 320). The radio waves (e.g., echoes from the radio waves transmitted by the transmitter (Tx) antenna 404 and radio waves transmitted by the interference radars 410) received at the receiver (Rx) antenna 408 are combined with information from the linear frequency modulator 402 at block 411, and the resulting output is the radar data 212.

The radar data 212 is received at the detection engine 210, which performs object detection. To do this, the detection engine 210 performs radar interference mitigation to remove or reduce interference in the radar data 212 caused by the interference radars 410 as is now described. A low pass filter (LPF) 412 performs initial filtering on the radar data 212 to remove high-frequency noise, prevent or reduce aliasing and interference, allowing the radar to focus on a desired signal component(s) that contain useful information about the target (e.g., the target vehicle 310). The low pass filter 412 enhances the signal-to-noise ratio of the radar data 212, improving the accuracy and clarity of the detection and measurement capabilities of the radar device 104. An analog-to-digital converter (ADC) 414 converts the radar data 212, which is received as analog signals, into digital form. Further processing can be performed on the digital representation of the radar data 212 as is now described.

According to one or more embodiments, the detection engine 210 performs temporal signal reconstruction 416 to reduce or eliminate interference in the radar data 212. Temporal signal reconstruction 416 can be performed as follows to identify effected samples per chirp (see FIG. 2B) and restore them per chirp, using corresponding samples in non-effected chirps.

The detection engine 210 performs a first detection stage that determines a median value for each chirp across the absolute values of the time samples. The detection engine 210 then determines the third quartile of the median values. Next, the detection engine 210 determines an interquartile range (IQR) using the subtraction of the third quartile and the first quartile, and identifies outliers based on a first threshold, which is the sum of the third quartile and one and a half times the IQR. More particularly, for a time-chirp signal x, the median of the absolute values for the samples across each of the chirps is calculated using the following equation:

$$m e {d}_{1} = med ian ( \vert x \vert ) .$$

The third quartile value q3₁ is calculated as follows:

$$q {3}_{1} = p e r c e n t i l e ( m e {d}_{1} , 0.75 ) .$$

The IQR is calculated using the following equation:

$${IQR}_{1} = IQR ( m e {d}_{1} ) .$$

The first threshold (th₁) is calculated as follows:

$$t {h}_{1} = q {3}_{1} + 1.5 {IQR}_{1} .$$

Once the first detection stage is performed, the detection engine 210 performs a first restoration stage to interpolate corrupted samples from neighboring samples. This is done by detecting which chirp medians are greater than the first threshold (th₁). According to one or more embodiments, the interpolation values (I) are determined using the following equations:

$$I = me {d}_{1} \geq t {h}_{1} and \\ \vert x \vert = interpolation ( I , ∼ I , \vert x [ ∼ I ] \vert ) .$$

Together, the first detection stage and the first restoration stage provide a global approach to detecting interference values within the radar data 212 and reconstructing the interference values using interpolating based on neighboring samples.

According to one or more embodiments, the detection engine 210 performs a second detection stage and a second reconstruction stage to provide a local approach to detecting interference values within the radar data 212. Together, the second detection and reconstruction stages localize thresholding per time (or range when operating in the spectral domain after the range FFT) (FIG. 2B). That is, the second detection stage detects interference on a per time basis, and then reconstructs the interference values using interpolating based on neighboring chirps' samples of that time.

The second detection and restoration stages look at the rows (time samples) to detect interference and to interpolate samples in that time using samples from other chirps in that time. More specifically, the second detection stage is performed using the following equations to perform detection on a per-time basis (e.g., ∀k, where k is each element in time):

$$q {3}_{2} [ k ] = p e r c e n t i le ( \vert x [ k ] \vert , 0.75 ) ∀ k ; \\ {IQR}_{2} [ k ] = IQR ( \vert x [ k ] \vert ) ∀ k ; and \\ {th}_{2} [ k ] = q {3}_{2} [ k ] + 1.5 {IQR}_{2} [ k ] ∀ k .$$

The second reconstruction stage is performed using the following equations, where each row has its own threshold:

$${I}_{2} = \vert x [ k ] \vert \geq {th}_{2} [ k ] ∀ k ; and \\ \vert x [ k ] \vert = interpolation ( {I}_{2} , ∼ {I}_{2} , \vert x [ k ] [ ∼ {I}_{2} ] \vert ) . ∀ k ;$$

It should be appreciated that, in some embodiments, the temporal signal reconstruction 416 includes the first detection stage and the first restoration stage, while in some other embodiments, the temporal signal reconstruction 416 includes the first detection stage, the first restoration stage, the second detection stage, and the second reconstruction stage.

The temporal signal reconstruction 416 generates first filtered data, which can be further processed as now described.

Once temporal signal reconstruction 416 is performed, a FFT (e.g., range FFT 418) can be performed to convert the first filter data from the time domain to a frequency (or range) domain (see FIG. 2B). The range FFT 418 transforms the time-domain radar signal into the frequency domain. Range FFT 418 aids in determining the range to a target from the vehicle 100 by analyzing the frequency components of the received signal, allowing the system 40 to accurately measure the distance to the target based on the time delay of the reflected signal (e.g., the echo 308).

After the range FFT 418 is performed, the detection engine 210 performs spectral signal reconstruction 420 to further reduce or eliminate interference in the radar data 212. The spectral signal reconstruction 420 is performed similarly to the temporal signal reconstruction 416 as is described herein. That is, the spectral signal reconstruction 420 can include performing a first detection, a first reconstruction, a second detection, and a second reconstruction to detect interference and interpolate values to replace the interference values.

The spectral signal reconstruction 420 generates second filtered data, which can be further processed as now described.

The detection engine 210 then performs a doppler FFT 422 on the second filtered data to analyze the frequency shift (e.g., Doppler shift) of the received signals (e.g., the echo 308) caused by the relative motion between the vehicle 100 and the target vehicle 310. The doppler FFT 422 helps to determine the relative velocity of the targets, enabling the radar system to measure the speed at which objects are moving towards or away from the vehicle 100.

The detection engine 210 performs digital beam forming (DBF) 424 after the doppler FFT 422 to direct and shape the beam pattern of the antenna array (e.g., the transmitter (Tx) antenna 404 and the receiver (Rx) antenna 408). The DBF 424 provides precise control of the beam direction by adjusting the phase and amplitude of the signals received or transmitted by each element of the antenna array (e.g., the transmitter (Tx) antenna 404 and the receiver (Rx) antenna 408), enabling improved target detection, tracking, and interference rejection.

The detection engine 210 then performs object detection using detector 426. The detector 426 identifies and locates objects (e.g., the target vehicle 310). To do this, the detector 426 determines the time delay and frequency shift of the echoes (e.g., the echo 308) to determine the distance and/or speed of the target vehicle 310.

Turning now to FIG. 5, a flow diagram of a method 500 for radar interference mitigation for a vehicle is provided according to one or more embodiments. The method 500 can be implemented using any suitable system or device. For example, the method 500 can be implemented using the processing system 102 of FIGS. 1 and 2, and/or the like, including combinations and/or multiples thereof. The method 500 is now described with reference to FIGS. 1-4 but is not so limited.

The method 500 begins at block 502, where the detection engine 210 receives radar data 212. The radar data 212 is captured by the radar device 104 of the vehicle 100 and is indicative of an environment in which the vehicle operates. That is, the radar data 212 includes data representative of the environment in proximity to (e.g., within an operable range of the radar device 104) the vehicle 100. The radar data 212 also includes interference (e.g., interference 326 from the radar device 322 of the interfering vehicle 320).

At block 504, the detection engine 210 performs temporal signal reconstruction on the radar data prior to performing a FFT (e.g., the range FFT 418) on the radar data 212 to generate first filtered data as described herein. The FFT generates ranging data using the first filtered data. According to one or more embodiments, the temporal signal reconstruction includes performing a detection stage and a reconstruction stage to detect interference values within the radar data and interpolate replacement values to replace the interference values.

At block 506, the detection engine 210 performs spectral signal reconstruction on the ranging data subsequent to performing the FFT (e.g., the range FFT 418) on the ranging data to generate second filtered data as described herein. According to one or more embodiments, the spectral signal reconstruction includes performing a detection stage and a reconstruction stage to detect interference values within the ranging data and interpolate values to replace the interference values.

At block 508, the detection engine 210 detects an object (e.g., the target vehicle 310) in the environment based at least in part on the second filtered data.

Additional processes also may be included, and it should be understood that the processes depicted in FIG. 5 represent illustrations, and that other processes may be added, or existing processes may be removed, modified, or rearranged without departing from the scope of the present disclosure. It should also be understood that the processes depicted in FIG. 5 may be implemented as programmatic instructions stored on a non-transitory computer-readable storage medium that, when executed by a processor (e.g., the processing device 202 of FIG. 2A) of a computing system (e.g., the processing system 102 of FIGS. 1 and 2), cause the processor to perform the processes described herein.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A computer-implemented method for radio detecting and ranging (radar) interference mitigation for a vehicle, the method comprising:
receiving radar data, the radar data captured by a radar device of the vehicle and being indicative of an environment in which the vehicle operates, the radar data including interference;
performing temporal signal reconstruction on the radar data prior to performing a fast Fourier transform (FFT) on the radar data to generate first filtered data, wherein the FFT generates ranging data using the first filtered data;
performing spectral signal reconstruction on the ranging data subsequent to performing the FFT on the ranging data to generate second filtered data; and
detecting an object in the environment based at least in part on the second filtered data.

2. The computer-implemented method of claim 1, wherein the temporal signal reconstruction comprises performing a detection stage and a reconstruction stage to detect interference values within the radar data and interpolate replacement values to replace the interference values.

3. The computer-implemented method of claim 2, wherein the detection stage comprises determining a median absolute value of time samples for each chirp across a plurality of chirps of the radar data, determining a third quartile of median values, determining an interquartile range (IQR) using subtraction of the third quartile and a first quartile, and identifying outliers based on a first threshold.

4. The computer-implemented method of claim 2, wherein the detection stage comprises a first detection phase, and wherein the temporal signal reconstruction further comprises a second detection stage, wherein the second detection stage comprises determining a third quartile of absolute samples values across chirps of a plurality of chirps for each time index, determining the interquartile range (IQR) using subtraction of the third quartile of the absolute samples values and a first quartile of the absolute samples values, and identifying outliers based on a second threshold.

5. The computer-implemented method of claim 3, wherein the reconstruction stage comprises detecting which points within the radar data are greater than the first threshold, and interpolating the replacement values to replace the points greater than the first threshold based on neighboring points.

6. The computer-implemented method of claim 1, wherein the temporal signal reconstruction comprises performing a first detection stage, a first restoration stage, a second detection stage, and a second reconstruction stage to detect interference values within the radar data and interpolate values to replace the interference values.

7. The computer-implemented method of claim 1, wherein the spectral signal reconstruction comprises performing a detection stage and a reconstruction stage to detect interference values within the ranging data and interpolate values to replace the interference values, wherein the detection stage comprises determining a median absolute value of range samples for each of a plurality of chirps of the ranging data, determining a third quartile of the median values, determining an interquartile range (IQR) using a subtraction of a third quartile and a first quartile, and identifying outliers based on a first threshold.

8. The computer-implemented method of claim 7, wherein the detection phase comprises a first detection phase, and wherein the temporal signal reconstruction further comprises a second detection stage, wherein the second detection stage comprises determining a third quartile of absolute samples values across the chirps of the plurality of chirps for each range index, determining the IQR using subtraction of the third quartile of the absolute samples values and a first quartile of the absolute samples values, and identifying outliers based on a second threshold.

9. The computer-implemented method of claim 7, wherein the reconstruction stage comprises detecting which points within the ranging data are greater than the first threshold, and interpolating replacement values to replace the points greater than the first threshold based on neighboring points.

10. The computer-implemented method of claim 1, wherein the spectral signal reconstruction comprises performing a first detection stage, a first restoration stage, a second detection stage, and a second reconstruction stage to detect interference values within the ranging data and interpolate values to replace the interference values.

11. A vehicle comprising:
a radar device, the radar device emitting radio waves and detecting echoes that bounce back when the radio waves encounter an object;
a processing system, the processing system comprising:
a memory comprising computer readable instructions; and
a processing device for executing the computer readable instructions, the computer readable instructions controlling the processing device to perform operations for radio detecting and ranging (radar) interference mitigation, the operations comprising:
receiving radar data from the radar device, the radar data being indicative of an environment in which the vehicle operates, the radar data including interference;
performing temporal signal reconstruction on the radar data prior to performing a fast Fourier transform (FFT) on the radar data to generate first filtered data, wherein the FFT generates ranging data using the first filtered data;
performing spectral signal reconstruction on the ranging data subsequent to performing the FFT on the ranging data to generate second filtered data; and
detecting an object in the environment based at least in part on the second filtered data.

12. The vehicle of claim 11, wherein the temporal signal reconstruction comprises performing a detection stage and a reconstruction stage to detect interference values within the radar data and interpolate replacement values to replace the interference values.

13. The vehicle of claim 12, wherein the detection stage comprises determining a median absolute value of time samples for each chirp across a plurality of chirps of the radar data, determining a third quartile of median values, determining an interquartile range (IQR) using subtraction of the third quartile and a first quartile, and identifying outliers based on a first threshold.

14. The vehicle of claim 13, wherein the reconstruction stage comprises detecting which points within the radar data are greater than the threshold, and interpolating the replacement values to replace the points greater than the threshold based on neighboring points.

15. The vehicle of claim 11, wherein the temporal signal reconstruction comprises performing a first detection stage, a first restoration stage, a second detection stage, and a second reconstruction stage to detect interference values within the radar data and interpolate values to replace the interference values.

16. The vehicle of claim 11, wherein the spectral signal reconstruction comprises performing a detection stage and a reconstruction stage to detect interference values within the ranging data and interpolate values to replace the interference values.

17. The vehicle of claim 16, wherein the detection stage comprises determining a median absolute values of range samples across each of a plurality of chirps of the ranging data, determining a third quartile of the median values, determining an interquartile range (IQR) using subtraction of a third quartile and a first quartile, and identifying outliers based on a threshold.

18. The vehicle of claim 17, wherein the reconstruction stage comprises detecting which points within the ranging data are greater than the threshold, and interpolating replacement values to replace the points greater than the threshold based on neighboring points.

19. The vehicle of claim 11, wherein the spectral signal reconstruction comprises performing a first detection stage, a first restoration stage, a second detection stage, and a second reconstruction stage to detect interference values within the ranging data and interpolate values to replace the interference values.

20. A method comprising:
receiving radar data, the radar data captured by a radar device of a vehicle and being indicative of an environment in which the vehicle operates, the radar data including interference;
performing initial filtering on the radar data using a low pass filter to generate filtered radar data;
converting the filtered radar data from analog signals into digital form to generate digital filtered radar data;
performing temporal signal reconstruction on the digital filtered radar data to generate first filtered data;
performing a range fast Fourier transform (FFT) to convert the first filtered data from a time domain to a frequency domain to generate ranging data;
performing spatial signal reconstruction on the ranging data to generate second filtered data;
performing a doppler FFT to analyze a frequency shift of the second filtered data;
performing digital beam forming after the doppler FFT; and
detecting an object in the environment based at least in part on the second filtered data subsequent to performing the doppler FFT and the digital beam forming.
